(19) United States
(12) Patent Application Publication
(10) Pub. No.: US 2026/0350469 A1
(43) Pub. Date: Nov. 5, 2026

(54) LEARNING DEVICE AND FUTURE TRAJECTORY PREDICTION SYSTEM

(71) Applicant: TOYOTA JIDOSHA KABUSHIKI KAISHA, Toyota-shi Aichi-ken (JP)

(72) Inventors: Kohtaro TANAKA, Sunto-gun Shizuoka-ken (JP); Yoshiyuki USUI, Utsunomiya-shi Tochigi-ken (JP); Taichi KAWANAI, Shizuoka-shi Shizuoka-ken (JP)

(73) Assignee: TOYOTA JIDOSHA KABUSHIKI KAISHA, Toyota-shi Aichi-ken (JP)

(21) Appl. No.: 19/653,675

(22) Filed: Apr. 21, 2026

(30) Foreign Application Priority Data
Apr. 23, 2025 (JP) 2025-071242

(51) Int. Cl. G06N 20/00; G01S 13/58

(52) U.S. Cl. CPC G06N 20/00; G01S 13/58

(57) ABSTRACT

Identifier matching is performed on a first object and a second object recognized by a first recognition and position estimator with low performance and a second recognition and position estimator with high performance, respectively, and when these objects are regarded as the same object, a common identifier is assigned. Furthermore, regarding the estimated positions of the first and second objects to which the common identifier is assigned, the time-series data of the estimated position of the second object in the second extraction section ahead of the first extraction section is regarded as the ground truth future trajectory of the first object, and the learning value of the internal parameters of the trajectory predictor is calculated based on the similarity with the future trajectory of the first object predicted based on the time-series data of the estimated position of the first object in the first extraction section.

### CROSS-REFERENCE TO RELATED APPLICATION

The present application claims priority under 35 U.S.C. §119 to Japanese Patent Application No. 2025-071242, filed on Apr. 23, 2025, the contents of which application are incorporated herein by reference in their entirety.

### TECHNICAL FIELD

The present disclosure relates to a technology for predicting a future trajectory of an object through recognition of the object.

### BACKGROUND

JP2024004450A discloses a learning method for a model that generates a future trajectory of an object around an autonomous driving vehicle. In this learning method, the past trajectory of the object is generated based on the positional information of the object around the autonomous driving vehicle with reference to a specific time. In this learning method, the driving environment information of the autonomous driving vehicle is created based on the past trajectory of the object and high-precision map information around the autonomous driving vehicle. In this learning method, the ground truth trajectory of the object after the specific time is generated using this driving environment context information as teacher data. Then, the DNN (deep neural network) is trained based on the difference between the ground truth trajectory and the past trajectory.

Examples of documents showing the technical level of the technical field relating to the present disclosure include JP2024020237A and JP2023027777A in addition to JP2024004450A.

The learning method of JP2024004450A performs DNN learning on the premise that the positional information of the object is correct. However, in a mobile object such as an autonomous driving vehicle, a predictor that predicts the future trajectory of an object may be implemented in combination with a recognition and position estimator that performs recognition and position estimation of the object with low performance. The reason for this is that the performance of an object recognition and position estimator tends to be sacrificed in order to improve the real-time performance of a future trajectory predictor. Since the performance of a computer mounted on a moving object is limited, the amount of calculation may be reduced by sacrificing the performance of the object recognition and position estimator.

Therefore, when the predictor of the future trajectory of JP2024004450A, which may have been trained based on object positional information with few errors, is combined with an estimator that outputs object recognition and position information with errors, the prediction accuracy of the future trajectory of the object may decrease. Therefore, there is room for improvement from the aspect of establishing a learning method for a future trajectory predictor that takes into account the output tendency of the object recognition and position estimator with low performance.

An object of the present disclosure is to provide a technique capable of suppressing a decrease in the prediction accuracy of a future trajectory of an object even when combined with a recognition and position estimator with low object recognition and position estimation performance.

### SUMMARY

A first aspect of the present disclosure is a learning device and has the following features.

The learning device includes a first recognition and position estimator, a second recognition and position estimator, an identifier matching and section extractor, a trajectory predictor, and a learning value calculator. The first recognition and position estimator recognizes an object existing in a frame acquired by a recognition sensor and estimates the position of the object. The second recognition and position estimator recognizes an object existing in the frame, and estimates the position of the object. The second recognition and position estimator has higher object recognition and position estimation performance than those of the first recognition and position estimator. The identifier matching and section extractor assigns a common identifier to a first object and a second object that are regarded as the same object, based on time-series data of an estimated position of the first object indicating an object recognized by the first recognition and position estimator, and time-series data of an estimated position of the second object indicating an object recognized by the second recognition and position estimator. The identifier matching and section extractor also extracts time-series data of a first extraction section from time-series data of the estimated position of the first object to which the common identifier is assigned, and extracts time-series data of a second extraction section, ahead of the first extraction section, from time-series data of the estimated position of the second object to which the common identifier is assigned. The trajectory predictor predicts a future trajectory of the first object ahead of the first extraction section based on time-series data of the estimated position of the first object in the first extraction section. The learning value calculator regards the time-series data of the estimated position of the second object in the second extraction section as a ground truth future trajectory of the first object, and calculates a learning value of an internal parameter of the trajectory predictor based on a similarity between the ground truth future trajectory and the predicted future trajectory of the first object ahead of the first extraction section.

A second aspect of the present disclosure is a future trajectory prediction system, which has the following features.

The future trajectory prediction system includes a recognition sensor, a recognition and position estimator, and a trajectory predictor. The recognition and position estimator recognizes an object existing in a frame acquired by a recognition sensor, and estimates a position of the object. The trajectory predictor is the trajectory predictor in the first aspect. The trajectory predictor predicts a future trajectory of the object based on time-series data of the estimated position of the object recognized by the recognition and position estimator.

According to the first aspect, identifier matching is performed for the first object and the second object recognized by the first recognition and position estimator with low performance and the second recognition and position estimator with high performance, respectively, and if these objects are regarded as the same object, a common identifier is assigned. Furthermore, regarding the estimated positions of the first object and the second object to which the common identifier is assigned, the time-series data of the estimated position of the second object in the second extraction section after the first extraction section is regarded as the ground truth future trajectory of the first object, and the learning value of the internal parameter of the trajectory predictor is calculated based on the similarity with the future trajectory of the first object predicted based on the time-series data of the estimated position of the first object in the first extraction section. Therefore, even when a recognition and position estimator with the same performance as the first recognition and position estimator is implemented in combination with a trajectory predictor, reflecting the learning results in this trajectory predictor can suppress a decrease in the prediction accuracy of the future trajectory of the object.

According to a second aspect, since the trajectory predictor reflecting learning results is used, even if this trajectory predictor is combined with a recognition and position estimator having the same performance as the first recognition and position estimator, it is possible to suppress a decrease in prediction accuracy of the future trajectory of the object.

### BRIEF DESCRIPTION OF THE DRAWINGS

FIG. 1 is a diagram illustrating a configuration example of a system including a learning device according to an embodiment;

FIG. 2 is a diagram illustrating the functions of an identifier matching and section extractor included in a preprocessor;

FIG. 3 is a diagram illustrating the functions of the identifier matching and the section extractor;

FIG. 4 is a diagram illustrating a modified example of the function of the preprocessor;

FIG. 5 is a diagram illustrating a modified example of the identifier matching and the section extractor;

FIG. 6 is a diagram illustrating a configuration example of a future trajectory prediction system according to the embodiment;

FIG. 7 is a diagram showing a second configuration example of a future trajectory prediction system;

FIG. 8 is a diagram showing a modified example of a learning device corresponding to the second configuration example;

FIG. 9 is a diagram showing a first application example of the future trajectory prediction system;

FIG. 10 is a diagram showing a second application example of the future trajectory prediction system;

FIG. 11 is a diagram illustrating a third application example of the future trajectory prediction system;

FIG. 12 is a diagram illustrating a fourth application example of the future trajectory prediction system; and

FIG. 13 is a diagram illustrating a fifth application example of the future trajectory prediction system.

### DESCRIPTION OF EMBODIMENT

Hereinafter, embodiments of the present disclosure will be described with reference to the drawings.

### 1. Learning Device

### 1-1. Configuration example

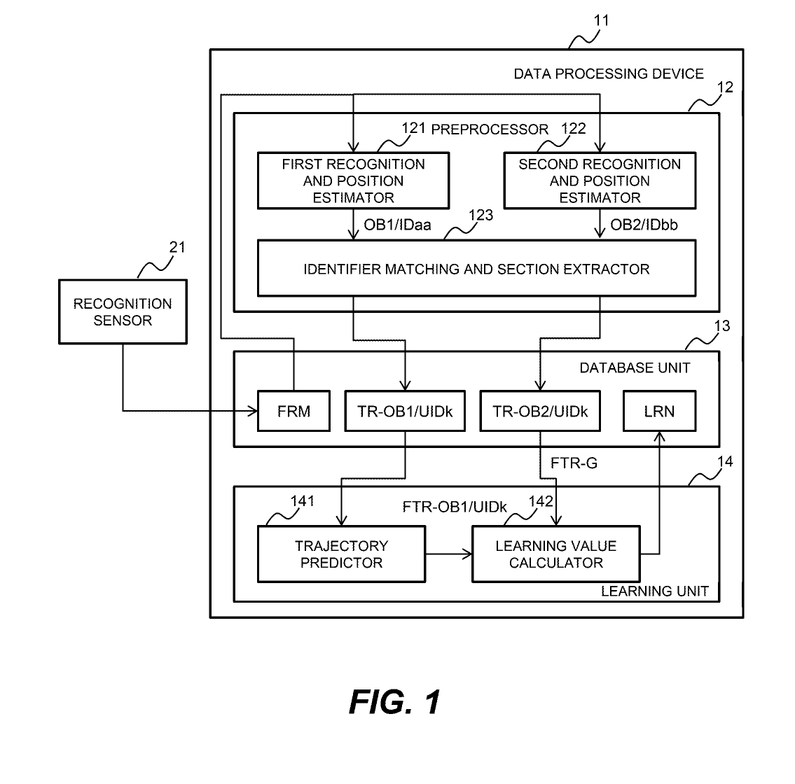

A learning device according to an embodiment of the present disclosure is a device for training a trajectory predictor that predicts a future trajectory of an object OB. FIG. 1 is a diagram showing a configuration example of a system including a learning device according to the embodiment. FIG. 1 depicts a system including a data processing device 11 and a recognition sensor 21. The data processing device 11 corresponds to an example of a learning device according to the embodiment. The data processing device 11 is typically a computer that includes one or more processing circuits (hereinafter, also simply referred to as "processing circuit") and one or more memory device (hereinafter, also simply referred to as "memory device").

The processing circuit performs various types of data process. Examples of the processing circuit include a CPU (Central Processing Unit), a GPU (Graphics Processing Unit), ASIC (Application Specific Integrated Circuits), and an FPGA (Field-Programmable Gate Array). The memory device stores various data. Examples of the memory device include a volatile memory, a non-volatile memory, a Hard Disk Drive (HDD), and a Solid State Drive (SSD). The data processing device 11 may include one or more data processing device.

FIG. 1 shows various functions of the data processing device 11 in blocks. These functions are realized, for example, by the cooperation of the processing circuit and the memory device described above. The various functions include a preprocessor 12, a database unit 13, and a learning unit 14. The preprocessor 12 includes a first recognition and position estimator 121, a second recognition and position estimator 122, and an identifier matching and section extractor 123. The learning unit 14 includes a trajectory predictor 141 and a learning value calculator 142. The functions of the preprocessor 12 and the learning unit 14 will be described below.

A frame FRM is input to the preprocessor 12 from the database unit 13. The frame FRM is output from the recognition sensor 21 at a constant cycle such as 10 Hz. The recognition sensor 21 is a sensor that detects the external environment of the recognition sensor 21. Examples of the recognition sensor 21 include a camera, LIDAR (Laser Imaging Detection and Ranging), and radar. The frame FRM includes the identifier data of the recognition sensor 21 that outputs the frame FRM, and the time stamp TS data.

The frame FRM is input to both the first recognition and position estimator 121 (hereinafter also referred to as a "preprocessor 121") and the second recognition and position estimator 122 (hereinafter also referred to as a "preprocessor 122"). The preprocessors 121 and 122 each perform recognition and position estimation of an object OB existing in the frame FRM. The difference between the preprocessor 121 and the preprocessor 122 lies in the performance of recognition and position estimation. That is, the recognition and position estimation performance of the preprocessor 121 is lower than that of the preprocessor 122. This is because the performance of a recognition and position estimator mounted on a moving object such as an automobile, an airplane, a drone, and a robot tends to be low. In the embodiment, such a low-performance recognition and position estimator is adopted for the preprocessor 121.

For example, if a machine learning-based recognizer is used for the preprocessor 122 and a non-machine learning-based recognizer is used for the preprocessor 121, the performance of the latter will be lower than that of the former. In another example, machine learning-based recognizers are used for both the preprocessors 121 and 122. Even in this case, performance differences occur due to differences in model architecture, the quality and quantity of training data, trained weights, and the like.

In object recognition by the preprocessors 121 and 122, an identifier ID is assigned to an object OB existing within a frame FRM. In this object recognition, the type of an object OB (e.g., a road user such as a walker) may be estimated, and a feature quantity of the object OB may be estimated. Data of an estimated position EP of the object OB recognized by the preprocessor 121 (hereinafter, also referred to as a "first object OB1") (e.g., data in an ECEF coordinate system format or data in a coordinate system format centered on the position of the recognition sensor 21) is combined with the identifier ID assigned to the first object OB1 and input to the identifier matching and section extractor 123 (hereinafter, also referred to as a "preprocessor 123"). Similar to the data of the estimated position EP of the first object OB1, the data of the estimated position EP of the object OB (hereinafter also referred to as a "second object OB2") recognized by the preprocessor 122 is also combined with the identifier ID assigned to the second object and input to the preprocessor 123.

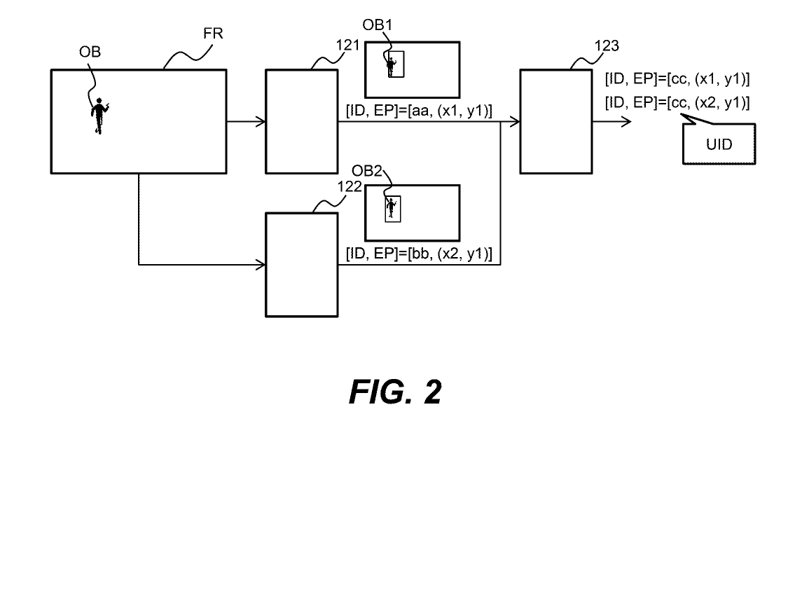

Object recognition by the preprocessors 121 and 122, and position estimation of the recognized objects by these preprocessors are performed for each frame FRM. Therefore, the time-series data of the estimated position EP of the first object OB1 and second object OB2 is input to the preprocessor 123. Based on the time-series data of the estimated positions EP of these objects, the preprocessor 123 assigns a common identifier UID to the first object OB1 and the second object OB2 that are regarded as the same object. FIG. 2 is a diagram illustrating a first function (identifier matching function) of the preprocessor 123. FIG. 2 depicts a combination[ID, EP]=[aa, (x1, y1)] of the identifier ID and the estimated position EP of the first object on the output side of the preprocessor 121. FIG. 2 also depicts a combination [ID, EP]=[bb, (x2, y1)] of the identifier ID and the estimated position EP of a second object OB2 on the output side of the preprocessor 122.

For example, the preprocessor 123 regards an object OB having the shortest distance of the estimated position EP and the smallest size difference for the same frame FRM of the time stamp TS as the same object. In another example, at least one of the difference between the distance and the size of the estimated position EP is combined with a feature quantity of the object OB, and the object OB having the highest similarity of the feature quantity is regarded as the same object. For the first object OB1 and the second object OB2 that are regarded as the same object, data of the identifier ID is updated. In the example shown in FIG. 2, the identifiers ID of a first object OB1 and a second object OB2, which are regarded as the same object, are replaced with a common identifier UID(cc).

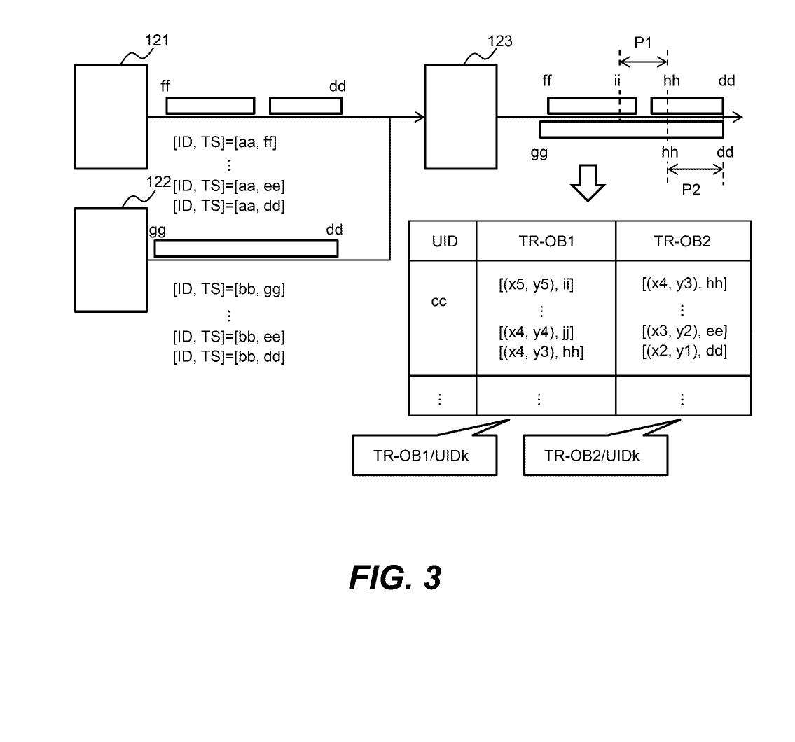

The preprocessor 123 extracts the time-series data of a first section P1 from the time-series data of an estimated position EP of the first object OB1, and extracts the time-series data of a second section P2 from the time-series data of the estimated position EP of the second object OB2. The time-series data of the estimated position EP is extracted by focusing on the time-series data to which a common identifier UID is assigned. FIG. 3 is a diagram illustrating a second function (section extraction function) of the preprocessor 123. FIG. 3 depicts time-series data of an estimated position EP of a first object OB1 to which an identifier ID (aa) is assigned on the output side of a preprocessor 121, and time-series data of an estimated position EP of a second object OB2 to which an identifier ID (bb) is assigned on the output side of a preprocessor 122.

When the first object with an identifier (aa) and the second object with an identifier (bb) are regarded as the same object, the preprocessor 123 sets the timing to divide the time-series data of the estimated position EP based on the data of the timestamps TS (dd, ee, ff, gg) of the frames FRM of these objects. For example, the setting of the division timing is set such that a first section P1 and a second section P2 are continuous in time series using a preset division parameter. In FIG. 3, the division timing is set to a timestamp TS (hh). A section from a timestamp TS (ii) before the timestamp TS (hh) to the timestamp TS (hh) corresponds to the first section P1. A section from the timestamp TS (hh) to a timestamp (dd) after the timestamp (hh) corresponds to the second section P2. The lengths of the first section P1 and the second section P2 may be the same or different.

Once the division timing is set, time-series data of an estimated position EP in the first section P1 and the second section P2 is extracted. Here, the time-series data of the estimated position EP in the first section P1 can be considered a trajectory TR of the first object OB1 in the first section P1 (hereinafter, also referred to as a "trajectory TR-OB1"). The time-series data in the second section P2 of the estimated position EP of the second section P2 can be considered as a trajectory TR of the second object OB2 (hereinafter, also referred to as a "trajectory TR-OB2"). In this case, the trajectories TR-OB1 and TR-OB2 extracted from time-series data to which a common identifier UIDk (k≥1) is assigned can be represented as trajectories TR-OB1/UIDk and TR-OB2/UIDk, respectively. The trajectories TR-OB1/UIDk and TR-OB2/UIDk are stored in the database unit 13.

The preprocessing by the preprocessors 121, 122, and 123 is repeated until the number of data of the frame FRM processed in this preprocessing reaches a preset number-of-frames parameter.

Returning to FIG. 1, the trajectories TR-OB1/UIDk and TR-OB2/UIDk are input from a database unit 13 to a learning unit 14. A trajectory TR-OB1/UIDk is input to a trajectory predictor 141 (hereinafter, also referred to as a "learning unit 141"). The learning unit 141 is an object of training in the embodiment. The learning unit 141 predicts a future trajectory FTR of an object OB from a trajectory TR of the object OB, which is input to the learning unit 141, using a prediction model and internal parameters of this prediction model. When the trajectory TR-OB1/UIDk is input, the learning unit 141 predicts the future trajectory FTR-OB1/UIDk. The future trajectory FTR-OB1/UIDk includes time-series data of a predicted position of the first object OB1 ahead of the first section P1.

By the way, the time-series data of the estimated position EP of the first object OB1 may have a blank due to non-detection or false detection of first object. If there are many blanks, the reliability of the future trajectory FTR-OB1/UIDk decreases. In addition, a data scale may vary greatly depending on a coordinate system of a position of the first object OB1, and the first object includes an object that makes complicated movements such as a walker. Therefore, when there is a blank in the time-series data of the estimated position EP of the first object OB1, the learning unit 141 fills this blank with a blank specific value. Subsequently, the learning unit 141 may normalize the time-series data of the estimated position EP, and calculate a normalized future trajectory FTR-OB1/UIDk by encoding and decoding the normalized time-series data. Subsequently, the learning unit 141 inversely normalizes the normalized future trajectory FTR-OB1/UIDk to restore the scale. In the learning unit 141, the future trajectory FTR-OB1/UIDk may be calculated through a series of processes.

The trajectory TR-OB2/UIDk is input to a learning value calculator 142 (hereinafter, also referred to as a "learning unit 142"). The future trajectory FTR-OB1/UIDk from the learning unit 141 is also input to the learning unit 142. The learning unit 142 regards the trajectory TR-OB2/UIDk as a ground truth future trajectory FTR-G, and compares it with the future trajectory FTR-OB1/UIDk. The reason for regarding the trajectory TR-OB2/UIDk as the future trajectory FTR-G is that the trajectory TR-OB2/UIDk is an output of the high-performance preprocessor 122. In comparing trajectories, for example, a similarity index (e.g., a loss function) between a ground truth future trajectory FTR-G (i.e., the trajectory TR-OB2/UIDk) and a future trajectory FTR-OB1/UIDk is calculated.

Once the similarity index is calculated, the learning unit 142 calculates a differential value of an internal parameter (e.g., a weight) so that the similarity index increases. The internal parameter is of a prediction model used in processing by the learning unit 141. When the differential value of an internal parameter is calculated, the learning unit 142 calculates an update value (that is, a learning value LRN) of the internal parameter using the differential value and a preset learning rate parameter.

The learning processing by the learners 141 and 142 is repeated until the number of updates of the internal parameters updated in this learning processing reaches a preset update number parameter. The learning value LRN obtained in this way is stored in the database unit 13. The learning value LRN is applied to a prediction model having the same architecture as a prediction model (hereinafter, also referred to as "a learning model") used in the process by the learning unit 141, for example. In this way, in the case where the prediction model is combined with a low-performance recognition and position estimator and mounted on a moving object, it is possible to suppress a decrease in the prediction accuracy of the future trajectory of the object using the prediction model.

### 1-2. Modified example

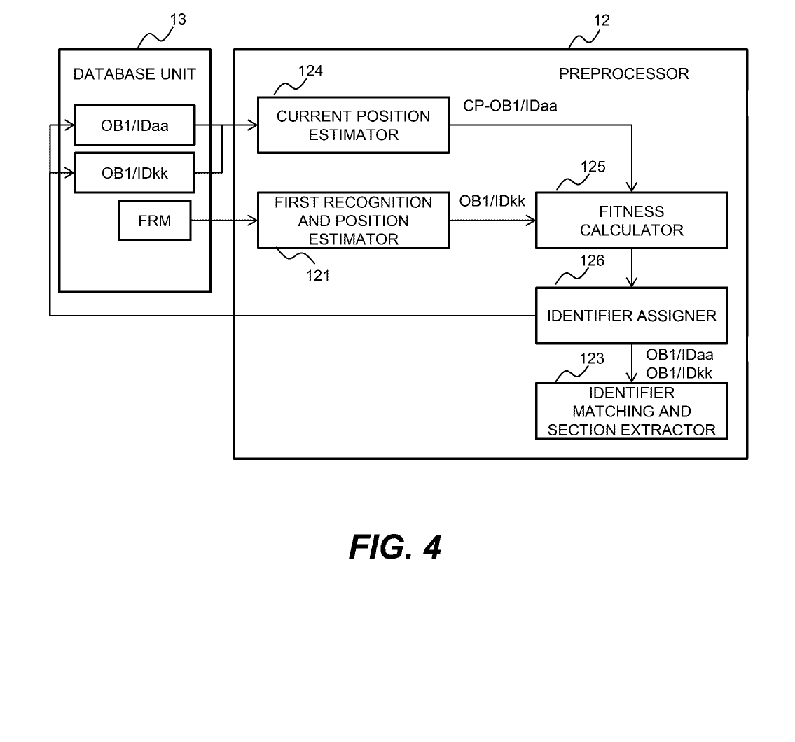

FIG. 4 is a diagram illustrating a modified example of the function of the preprocessor 12. In the configuration example described with reference to FIG. 1, a frame FRM is input from the database unit 13 to the preprocessors 12 (the preprocessors 121 and 122), and the identifier ID is assigned to the object OB (the first object OB1 and the second object OB2). In contrast, in the configuration example of FIG. 4, in addition to the preprocessor 121 and the preprocessor 123, functions of a current position estimator 124, a fitness calculator 125, and an identifier assigner 126 are added. Although the preprocessor 122 is not depicted in FIG. 4, the functions of the current position estimator 124, the fitness calculator 125, and the identifier assigner 126 can be combined with the functions of the preprocessor 122.

In FIG. 4, after the identifier ID(kk) is assigned to a first object OB1 by the preprocessor 121, the estimated position EP of the first object OB1 is input to the fitness calculator 125 (hereinafter, also referred to as a "preprocessor 125"). The preprocessor 125 also receives an estimated actual position CP-OB1 of the first object OB1, to which an identifier ID ("aa" in the example of FIG. 4) has been assigned in a past process by the preprocessor 121. The estimated actual position CP-OB1 is a actual position of the first object OB1 estimated based on time-series data of an estimated position EP of the first object to which the identifier ID has been assigned in the past process. The estimation of the estimated actual position CP-OB1 is performed by a actual position estimator 124 (hereinafter, also referred to as "the preprocessor 124").

The preprocessor 125 calculates the fitness between an estimated position EP of the first object OB1 to which an identifier ID (kk) is assigned and an estimated actual position CP-OB1 of the first object to which an identifier ID (aa) is assigned in the example of FIG. 4. In calculating the fitness, the type and feature quantity of the first object OB1 estimated in object recognition may be used.

The identifier assigner 126 (hereinafter also referred to as a "preprocessor 126") receives the fitness from the preprocessor 125. When the degree of conformity is equal to or greater than a defined value, the preprocessor 126 regards a first object OB1 to which an identifier ID(kk) is assigned as the same object as the first object to which an identifier ID(aa) is assigned, and replaces the identifier ID(kk) with the identifier ID(aa). Otherwise, the preprocessor 126 does not replace the identifier ID (kk). The preprocessor 126 also outputs data of an estimated position EP of the first object OB1, judgement target, to the database unit 13. As a result, in the subsequent processing of the estimated actual position CP-OB1 by the preprocessor 124, the actual position of the first object OB1 to which the identifier ID (aa or kk) is assigned is estimated. The data of the estimated position EP is stored for each combination of the identifier ID and the frame FRM. When the number of data items of the estimated position EP for a certain identifier ID reaches the upper limit, the data items are deleted in order from the oldest timestamp TS.

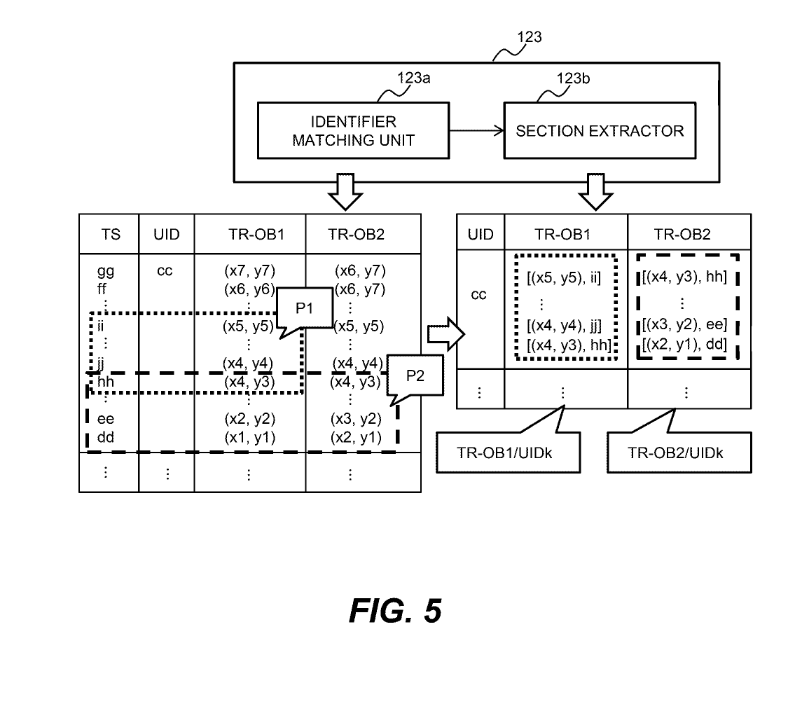

FIG. 5 is a diagram illustrating a modified example of the identifier matching and section extractor. In the functional example described with reference to FIG. 3, the first and second functions of the preprocessor 123 are realized in parallel. In contrast, in the functional example shown in FIG. 5, the first function and the second function are separated. The first function is realized by the identifier matching unit 123a (hereinafter also referred to as a "preprocessor 123a"). The second function is realized by a section extractor 123b (hereinafter, also referred to as a "preprocessor 123b").

For example, based on time-series data of the estimated positions EP of the first object OB1 and the second object OB2, the preprocessor 123a assigns a common identifier UID to the first object and second object OB2 that are regarded as the same object. Up to this point, the function is the same as that of the preprocessor 123 in FIG. 3. The preprocessor 123a arranges the time-series data of the estimated positions EP of first object OB1 and the second object OB2, to which the common identifier UID has been assigned, in the order of the time stamps TS to create a database, and stores the database in the database unit 13.

The preprocessor 123b refers to the database generated by the preprocessor 123a, and extracts the time-series data of the estimated position EP of the first object OB1 in the first section P1 (that is, the trajectory TR-OB1/UIDk) and the time-series data of the estimated position EP of the second object OB2 in the second section P2 (that is, the trajectory TR-OB2/UIDk) from the time-series data to which the common identifier UID is assigned. It is expected that the processing load will increase as the number of frames processed by the preprocessor 123 increases. In this regard, since the function of the preprocessor 123 is divided into the preprocessors 123a and 123b, the overall efficiency of the identifier matching process and the section extraction processing is expected to be improved.

### 2. Future trajectory prediction system

### 2-1. Configuration example

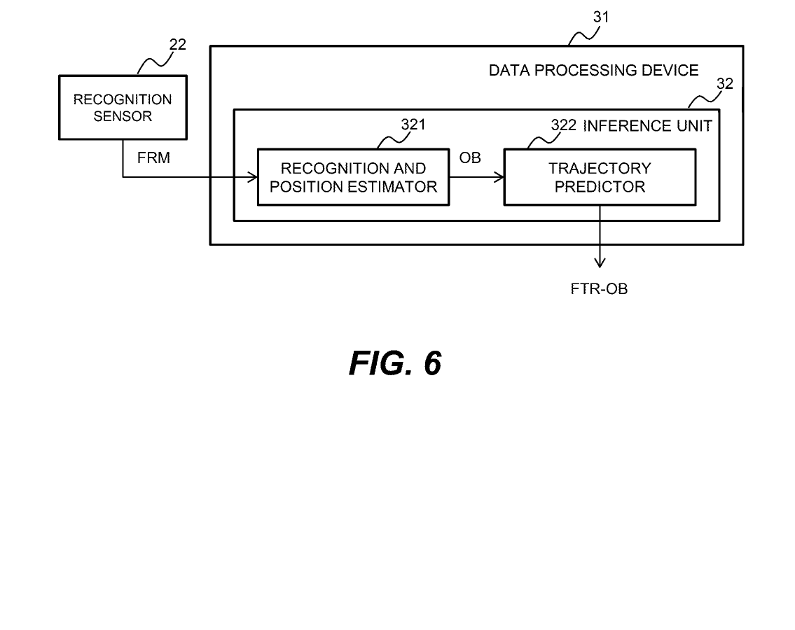

A future trajectory prediction system according to the embodiment (hereinafter, also referred to as a "prediction system") is a system that predicts a future trajectory of an object OB by a trajectory predictor including a prediction model to which a learning value LRN obtained by processing with the learning device described above is applied. FIG. 6 is a diagram illustrating a configuration example of the prediction system according to the embodiment. FIG. 6 depicts a system including a data processing device 31 and a recognition sensor 22. The system including the data processing device 31 and the recognition sensor 22 corresponds to an example of the prediction system according to the embodiment. The basic configuration of the data processing device 31 is the same as the configuration of the data processing device 11 described with reference to FIG. 1. An example of the recognition sensor 22 is the same as an example of the recognition sensor 21 described with reference to FIG. 1.

The system shown in FIG. 6 is implemented in mobile objects such as automobiles, airplanes, drones, and robot. The recognition sensor 22 detects the situation around the moving object in real time and inputs a frame FRM to the inference unit 32. The inference unit 32 includes a recognition and position estimator 321 (hereinafter also referred to as an “inference unit 321”) and a trajectory predictor 322 (hereinafter also referred to as an “inference unit 322”). The inference unit 321 has object recognition and position estimation performance equivalent to that of the preprocessor 121 described with reference to FIG. 1. Here, "equivalent" means not only the case where the performances completely match, but also the case where there are some advantages and disadvantages in the performances.

The inference unit 321 recognizes and estimates the position of an object OB existing within a frame FRM, and outputs time-series data of the estimated position EP of the object OB to the inference unit 322 together with an identifier ID assigned to the object OB. The inference unit 322 predicts a future trajectory FTR-OB of the object OB based on the time-series data of the estimated position EP of the object OB. The inference unit 322 includes a prediction model (hereinafter also referred to as an "implementation model") used for predicting a future trajectory. An implementation model has the same architecture as the learning model described above, and a learning value LRN is applied to this implementation model.

The application of the learning value LRN to the implementation model is performed, for example, when the inference unit 321 is implemented. When the learning value LRN is updated by learning of the learning model, the latest learning value LRN may be reflected in the implementation model by data communication between the data processing device 11 and the data processing device 31.

### 2-2. Modified example

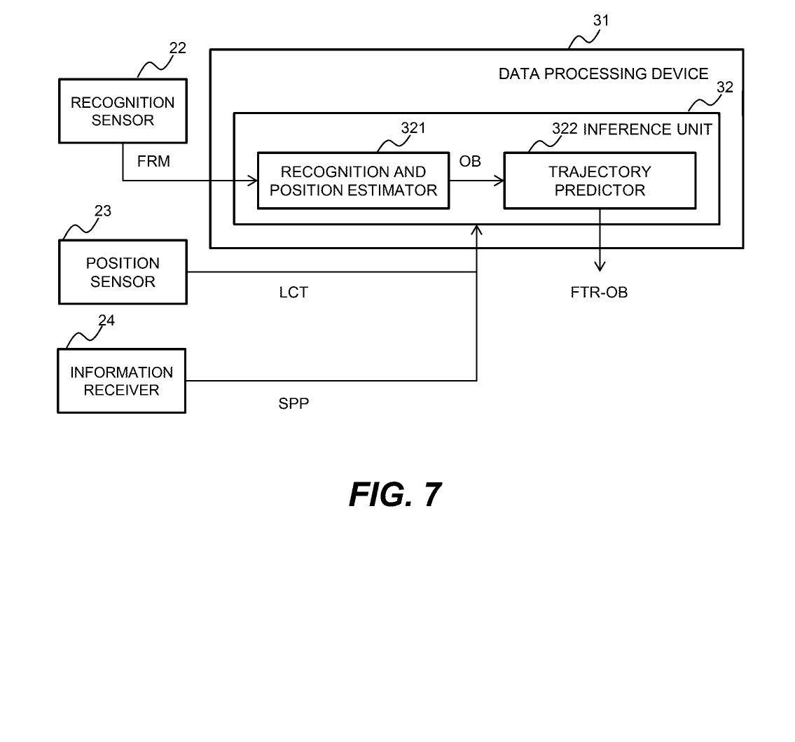

FIG. 7 is a diagram showing a second configuration example of the prediction system. In the prediction system described with reference to FIG. 6, the object recognition and position estimation performance of the inference unit 321 is low. Therefore, errors tend to occur in object recognition and position estimation. This error tendency may be caused by the structure or position of a road. For example, consider a case where a prediction system is implemented in an automobile and the automobile approaches a street corner. At a corner, an object (for example, a walker) beyond the corner may be hidden and the object may not be detected, and a signboard at a specific position of the corner may be erroneously detected as a walker.

In this regard, in the second configuration example, the prediction system includes a position sensor 23 and an information receiver 24. The position sensor 23 is a sensor (e.g., GPS) that detects the vehicle's ego position LCT. The information receiver 24 is a device that receives map data (road segmentation data) as supplemental information SPP from an external device. According to the vehicle's ego position LCT and the map data, it is possible to consider an error tendency specific to the vehicle's travel route in object recognition and position estimation by the inference unit 321, so that the prediction accuracy of the future trajectory FTR-OB by the inference unit 322 can be improved.

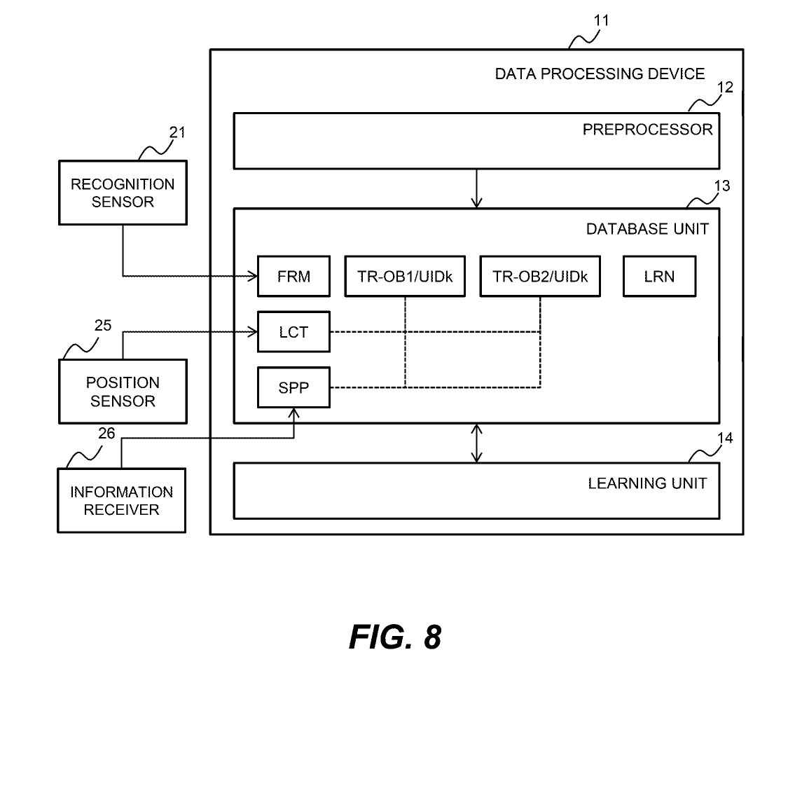

However, in an embodiment in which a prediction is performed based on an implementation model to which a learning value LRN has been applied, it is desirable that the ego position LCT and map data be used also in the processing for calculating the learning value LRN. FIG. 8 is a diagram showing a modified example of the learning device corresponding to the second configuration example. In FIG. 8, the ego position LCT and the supplemental information SPP acquired from the position sensor 25 and the information receiver 26 are stored in the database unit 13. Also, this additional information is associated with the trajectories TR-OB1/UIDk and TR-OB2/UIDk. Therefore, from the learning stage, the error tendency of object recognition and position estimation specific to the travel route of the automobile is considered. This leads to improving the prediction accuracy of a future trajectory FTR-OB by the implementation model to which a learning value LRN is applied.

The error tendency of the object recognition and position estimation by the inference unit 321 may be caused not only by the travel route of the automobile but also by the weather in the travel area of the automobile, the travel date and time (for example, time zone and day of the week), events held in the travel area, traffic regulations due to construction work being performed in the surrounding area, disasters that have occurred in the travel area, and the like. For example, when visibility is poor due to fog or rain, a distant object may not be detected, and the rain or fog may be misidentified as an object. During weekday commuting hours, when transportation is paralyzed due to events or disasters, traffic volume increases, which may lead to misallocation of identifier IDs to nearby walker, resulting in non-detection due to exceeding the number of detectable objects. In construction section, construction workers in locations where walker are not normally present may not be detected.

In this regard, the second configuration example enables object recognition and position estimation using the vehicle's ego position LCT and supplemental information SPP. Therefore, by taking into account the weather in the area where the vehicle is traveling, the date and time of travel, events being held in the area where the vehicle is traveling, traffic regulations due to construction work being carried out in the surrounding area, and error tendencies unique to disasters that have occurred in the area where the vehicle is traveling, it is possible to improve the prediction accuracy of a future trajectory FTR-OB by the inference unit 322. The weather information is exemplified as auxiliary weather information SPP. The time and day of the week information is exemplified as the supplemental information SPP of the movement date and time. The event holding information is exemplified as the supplemental information SPP of an event. The traffic information is exemplified as the supplemental information SPP of traffic regulations. The disaster information is exemplified as the supplemental information SPP of a disaster. The modified example described with reference to FIG. 8 is similarly applicable to the above-described learning using weather conditions and the like.

### 2-3. Application example

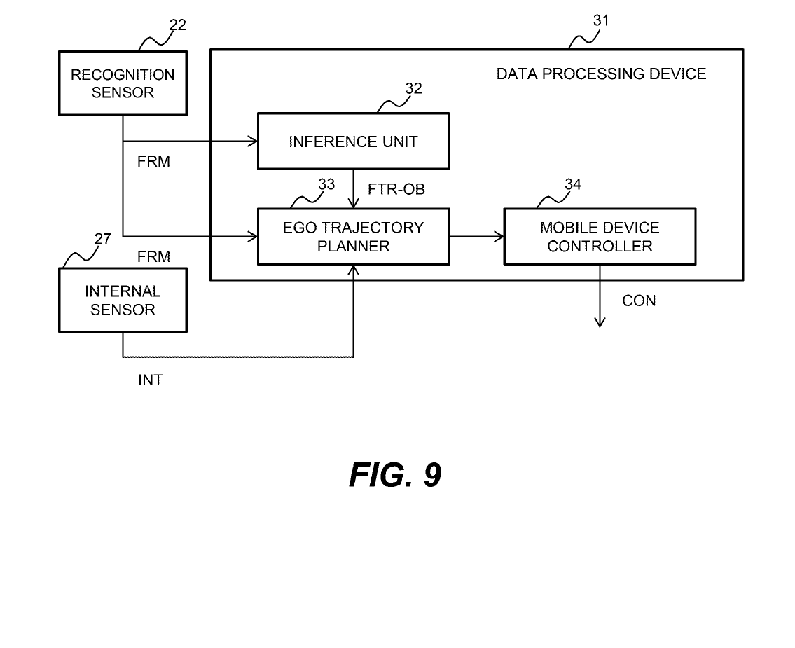

FIG. 9 shows a first application example of the prediction system. In the prediction system described with reference to FIG. 6, the inference unit 32 outputs a future trajectory FTR-OB of the object OB. In the example of FIG. 9, a trajectory that the mobile object should pass through is generated using this output, and the mobile device is controlled. The example of FIG. 9 is also a configuration example of an autonomous mobile system implemented in a mobile object. The configuration example of FIG. 9 includes an internal sensor 27. The internal sensor 27 detects the internal information INT (for example, speed, acceleration, yaw rate) of the mobile object. In the configuration example of FIG. 9, the data processing device 31 includes an ego trajectory planner 33 and a mobile device controller 34 in addition to the inference unit 32 shown in FIG. 6.

Based on the future trajectory FTR-OB of the object OB output from the inference unit 32, and internal information INT from the internal sensor 27, the ego trajectory planner 33 plans the trajectory (the ego trajectory) that a mobile object should pass through. The ego trajectory includes, for example, a set of target position of the mobile object, and a target speed for each target position. The mobile device controller 34 generates control information CON for a mobile device (e.g., a steering device, a driving device, and a braking device) such that the mobile object moves according to the ego trajectory that does not interfere with the future trajectory FTR-OB. The control information CON includes information on a control amount for reducing a deviation (for example, a lateral deviation, a yaw angle deviation, and a speed deviation) between a mobile object and its own trajectory.

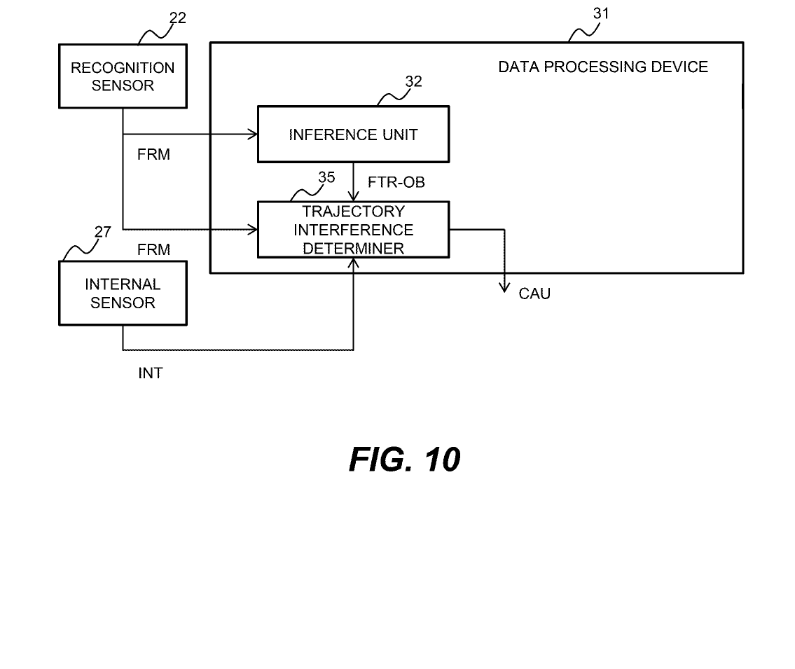

FIG. 10 is a diagram showing a second application example of the prediction system. In the autonomous traveling system described with reference to FIG. 9, an own trajectory that does not interfere with a future trajectory FTR-OB of the object OB was generated. In the example of FIG. 10, such an own trajectory is not generated. Instead, when the future trajectory FTR-OB is likely to interfere with the future trajectory of the moving object, warning information CAU is output to the operator of the moving object. The example of FIG. 10 is also a configuration example of a movement support system mounted on a mobile object. In the configuration example of FIG. 10, a data processing device 31 includes a trajectory interference determiner 35 in addition to an inference unit 32 shown in FIG. 6.

The trajectory interference determiner 35 predicts the future trajectory of the moving object, based on the frame FRM from the recognition sensor 22 and the internal information INT from the internal sensor 27. The trajectory interference determiner 35 also determines whether or not the future trajectory of the moving object interferes with the future trajectory FTR-OB of the object OB output from the inference unit 32. If it is determined that both interfere with each other, the trajectory interference determiner 35 outputs warning information CAU to an alarm device (for example, a user interface).

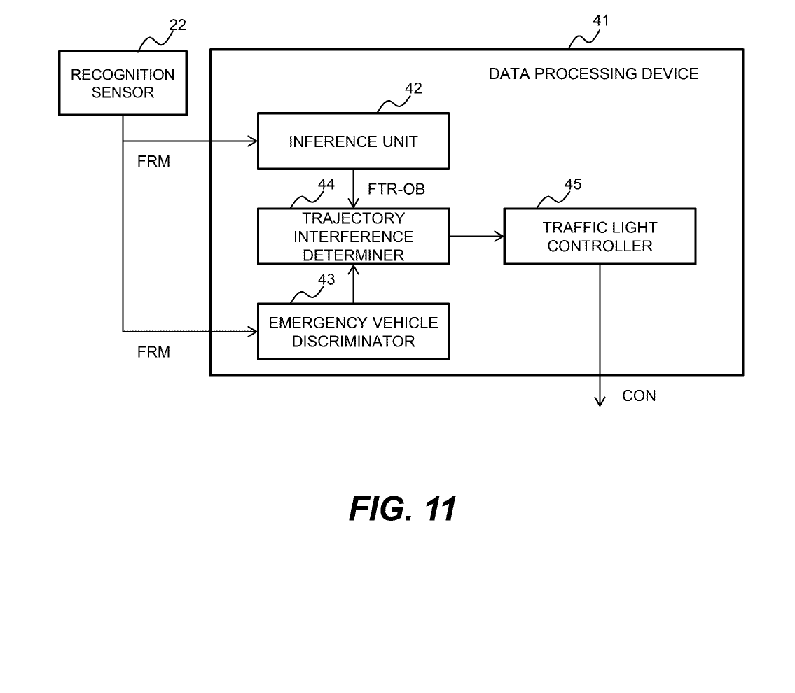

FIG. 11 is a diagram showing a third application example of the prediction system. In the travel support system described with reference to FIG. 10, it is determined whether there is interference between the future trajectory of the mobile object on which this system is implemented and the future trajectory FTR-OB of the object OB. In contrast, in the example of FIG. 11, it is determined whether there is interference between the future trajectory of an emergency vehicle entering an intersection and the future trajectory FTR-OB of another object OB entering the intersection. Then, when it is determined that these future trajectories interfere with each other, control information CON for a traffic light at the intersection is output.

The example in FIG. 11 is also a configuration example of a traffic support system implemented in traffic infrastructure (for example, traffic light, road construction such as pedestrian bridges) at an intersection. The configuration example in FIG. 11 includes a data processing device 41 and a recognition sensor 22. The basic configuration of the data processing device 41 is the same as the configuration of the data processing device 11 described with reference to FIG. 1. The data processing device 41 includes an inference unit 42, an emergency vehicle discriminator 43, a trajectory interference determiner 44, and a traffic light controller 45.

The function of the inference unit 42 is the same as that of the inference unit 32 shown in FIG. 9. An emergency vehicle discriminator 43 detects an emergency vehicle (e.g., an ambulance) entering an intersection based on the frame FRM. When an emergency vehicle is detected, the emergency vehicle discriminator 43 outputs the positional information of the emergency vehicle in the frame FRM to a trajectory interference determiner 44. When the positional information of the emergency vehicle is input, a trajectory interference determiner 44 identifies the emergency vehicle from among the objects OB input from the inference unit 42, and determines whether the future trajectory FTR-OB of the emergency vehicle interferes with that of another object OB at an intersection. If it is determined that these future trajectories interfere with each other, the trajectory interference determiner 44 outputs control information CON for prohibiting the other object OB from passing through the intersection to a traffic light at the intersection.

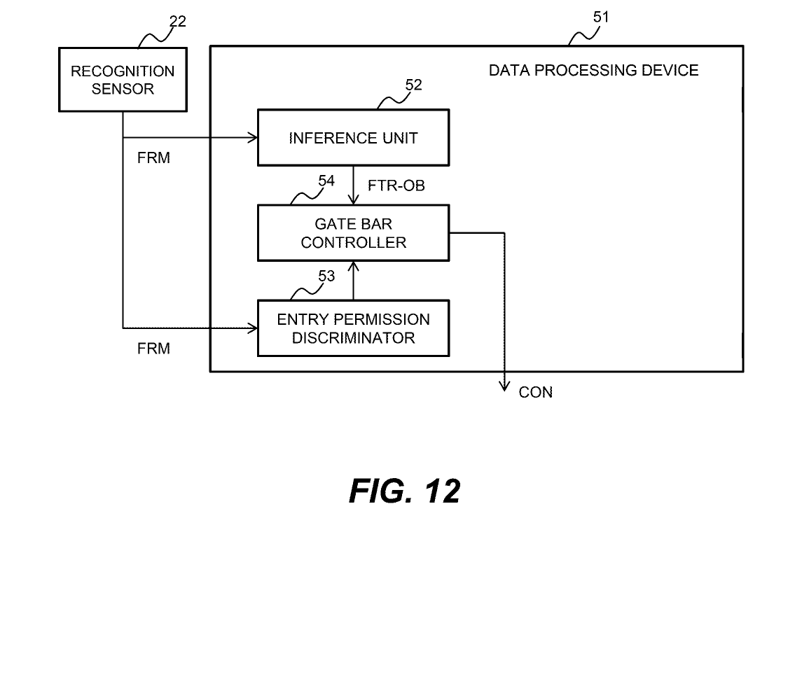

FIG. 12 is a diagram showing a fourth application example of the prediction system. In the traffic support system described with reference to FIG. 11, when an emergency vehicle entering an intersection is detected, the interference between the future trajectory FTR-OB of the emergency vehicle and that of another object OB entering the intersection is determined. In contrast, in the example of FIG. 1, when an object OB approaching the entrance of the controlled area is detected, the admission permission is determined using the future trajectory FTR-OB of this object OB.

The example of FIG. 12 is also a configuration example of an admission management system implemented in infrastructure (for example, a gate device) of the managed area. The configuration example in FIG. 12 includes a data processing device 51 and a recognition sensor 22. The basic configuration of the data processing device 51 is the same as the configuration of the data processing device 11 described with reference to FIG. 1. The data processing device 51 includes an inference unit 52, an entry permission discriminator 53, and a gate bar controller 54.

The function of the inference unit 52 is the same as that of the inference unit 32 shown in FIG. 9. The entry permission discriminator 53 detects an object (e.g., a walker, a vehicle) approaching an entrance of a managed area based on a frame FRM. When an object is detected, the entry permission discriminator 53 determines whether or not the detected object is eligible for entrance permission based on pre-registered information (e.g., image information, feature quantity information). If it is determined that the object is eligible for permission, the entry permission discriminator 53 transmits the positional information of the eligible object within the frame FRM to the gate bar controller 54. When the positional information of the object to be permitted is input, The gate bar controller 54 identifies a permission object from the objects OB inputted from the inference unit 42, and determines whether the future trajectory FTR-OB of this permission object has reached the installation position of the gate bar. When it is determined that the future trajectory FTR-OB has reached the installation position of the gate bar, the control information CON is output to the gate bar to support smooth passage of the permitted object.

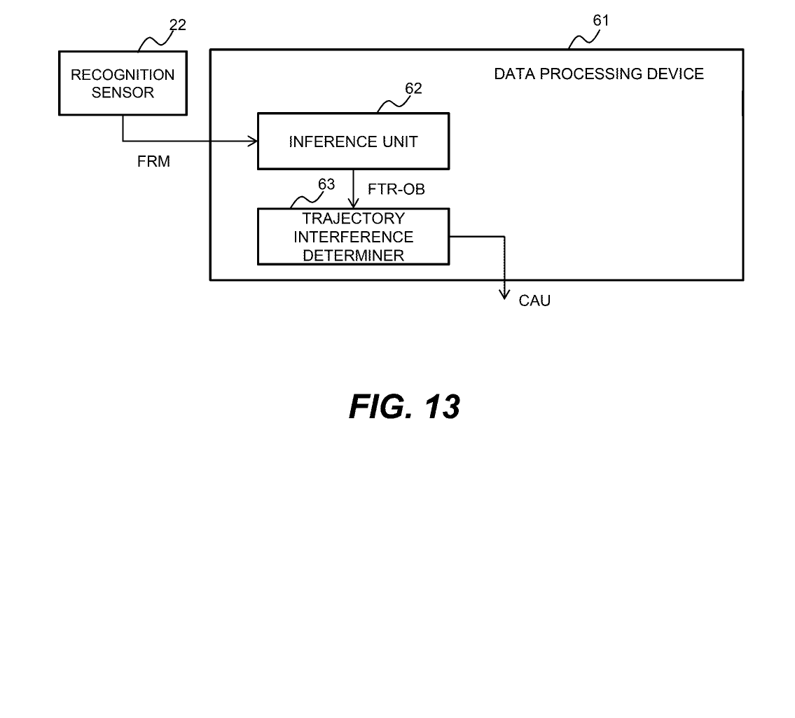

FIG. 13 is a diagram illustrating a fifth application example of the prediction system. In the movement support system described with reference to FIG. 10, it is determined whether there is interference between a future trajectory of the moving object on which this system is implemented and a future trajectory FTR-OB of the object OB. In contrast, in the example of FIG. 13, interference between the future trajectories FTR-OB of a plurality of objects OB is determined. Then, when it is determined that the future trajectories FTR-OB interfere with each other, the warning information CAU is output.

The example of FIG. 13 is also a configuration example of a traffic support system implemented in a traffic infrastructure (for example, road construction such as telephone pole and traffic light). The configuration example of FIG. 13 includes a data processing device 61 and the recognition sensor 22. The basic configuration of the data processing device 61 is the same as the configuration of the data processing device 11 described with reference to FIG. 1. The data processing device 61 includes an inference unit 62 and a trajectory interference determiner 63.

The function of the inference unit 62 is the same as that of the inference unit 32 shown in FIG. 9. The trajectory interference determiner 63 determines whether or not future trajectories FTR-OB of a plurality of objects OB inputted from an inference unit 62 interfere with each other. When it is determined that these future trajectories interfere with each other, the trajectory interference determiner 63 outputs a warning information CAU to an alarm device (for example, a speaker, a projector, etc.).

What is claimed is:

1. A learning device, comprising:
a first recognition and position estimator configured to recognize an object existing in a frame acquired by a recognition sensor, and configured to estimate the position of the object;
a second recognition and position estimator configured to recognize an object existing in the frame and configured to estimate the position of the object, wherein the second recognition and position estimator has higher object recognition and position estimation performance than those of the first recognition and position estimator;
an identifier matching and section extractor configured to assign a common identifier to a first object and a second object that are regarded as the same object based on time-series data of an estimated position of the first object indicating an object recognized by the first recognition and position estimator and time-series data of an estimated position of the second object indicating an object recognized by the second recognition and position estimator, configured to extract time-series data of a first extraction section from time-series data of the estimated position of the first object to which the common identifier is assigned, and configured to extract time-series data of a second extraction section, ahead of the first extraction section, from time-series data of the estimated position of the second object to which the common identifier is assigned;
a trajectory predictor configured to predict a future trajectory of the first object ahead of the first extraction section based on the time-series data of the estimated position of the first object in the first extraction section; and
a learning value calculator configured to regard the time-series data of the estimated position of the second object in the second extraction section as a ground truth future trajectory of the first object, and configured to calculate a learning value of an internal parameter of the trajectory predictor based on a similarity between the ground truth future trajectory and the predicted future trajectory of the first object ahead of the first extraction section.

2. The learning device according to claim 1,
wherein the identifier matching and section extractor is configured to identify the first object and the second object that are regarded as the same object, based on at least one of a distance between the estimated positions of the first object and the second object to which the common identifier is assigned, a difference in sizes of the first object and the second object, and a similarity in feature quantities of the first object and the second object.

3. The learning device according to claim 1,
wherein the section extractor is configured to set the first extracted section and the second extracted section such that these extracted sections are continuous in time series.

4. The learning device according to claim 1,
wherein the learning value calculator is configured to calculate the learning value of the internal parameter based on a differential value of the internal parameter such that a similarity between the ground truth future trajectory and the predicted future trajectory becomes large.

5. A future trajectory prediction system, comprising:
a recognition sensor;
a recognition and position estimator configured to recognize an object existing in a frame acquired by a recognition sensor, and configured to estimate a position of the object; and
the trajectory predictor according to claim 1, wherein the trajectory predictor configured to predict a future trajectory of the object based on time-series data of the estimated position of the object recognized by the recognition and position estimator.
